(19) United States
(12) Patent Application Publication
(10) Pub. No.: US 2022/0306952 A1
(43) Pub. Date: Sep. 29, 2022

(54) PROCESS FOR TREATING A FEEDSTOCK COMPRISING HALIDES

(71) Applicant: HALDOR TOPSØE A/S, Kgs. Lyngby (DK)

(72) Inventor: Lars JØRGENSEN, Greve (DK)

(73) Assignee: HALDOR TOPSØE A/S, Kgs. Lyngby (DK)

(21) Appl. No.: 17/610,836

(22) PCT Filed: Jun. 19, 2020
(86) PCT No.: PCT/EP2020/067197

§ 371 Date: Nov. 12, 2021

(30) Foreign Application Priority Data
Jun. 20, 2019 (DK) PA 2019 00753

(51) Int. Cl. C10G 67/02; C10G 69/06; B01D 1/06; B01D 61/02; C02F 1/04; C02F 1/44

(52) U.S. Cl. CPC C10G 67/02; C10G 69/06; B01D 1/065; B01D 61/025; C02F 1/048; C02F 1/441; C10G 2300/1011; C10G 2300/1003; C10G 2300/202; C02F 2101/36

(57) ABSTRACT

A process for conversion of a hydro-carbonaceous feed including ionic halides to a hydrocarbon product stream by hydrotreatment, wherein the stream is combined with wash water, the weight ratio between wash water and hydrocarbon product stream water is between 1:10 and 10:1, wherein the combined hydrocarbon product stream and wash water are separated in a non-polar stream of hydrocarbon product and a polar stream of wash water including ionic halides, such that from 50% of the ionic halides are transferred from the hydrocarbon product stream to the polar stream of wash water including ionic halides, wherein the polar stream of wash water is directed to a means of concentrating, to provide a stream of purified water and a stream of brine having a concentration of ionic halides being more than 2 times and less than 100 times above that of the polar stream of waste water including ionic halides.

### FIELD OF THE INVENTION

This invention relates to a process and a system for conversion of a hydrocarbonaceous feed comprising halides, and specifically a process and a system for removing halides from a hydrocarbon stream comprising one or more halides.

### BACKGROUND OF THE INVENTION

Refinery and petrochemical processes comprise a plurality of treatments of hydrocarbon rich streams in order to provide products or intermediates in the form of LPG, naphtha, gasoline, diesel, etc. Such treatments comprise hydro-treatment, hydro-cracking, steam-cracking, fractionation and stripping, as well as intermediate heat exchange and removal of impurities.

Hydrocarbonaceous feedstock may, depending on origin, contain heteroatoms, undesired in the downstream processing. The most abundant heteroatoms are sulfur, nitrogen and, mainly for feedstocks of biological origin, oxygen, which may be present in concentrations from 1000 ppmw to 10 wt %, and for oxygen even as high as 45 wt % in feedstocks derived from biological materials. These heteroatoms are converted hydrogen sulfide, ammonia, water and carbon oxides during refinery processes, which cause few challenges in the process plants. Other heteroatoms are typically metals, which typically are present in small amounts (0-10 ppmw) and precipitate on catalyst guard particles, and thus also cause few challenges in the process plants. However, when treating biomass or waste products such as plastic waste, heteroatoms may be present in much higher concentrations. For thermally decomposed waste, e.g. pyrolyzed plastic, the content of e.g. CI may be 1000 ppmw or higher, and after hydrotreament the organic CI will have been converted to HCl and may cause corrosion issues. It is therefore important to remove the heteroatoms early in the process, to minimize the effect on down-stream process steps. Similar issues may also be observed for biomass comprising halides, e.g. if originating from salt water.

WO 2015/050635 relates to a process for hydrotreating and removing halides from a hydrocarbon stream by hydrotreatment. The document is silent on the amount of water required for withdrawal of halides from the process and on the practical aspects of the process, except for an emphasis on the materials used being corrosion resistant.

From 30% or 80% to 90% or 100% of the organic halides in a hydrocarbonaceous feedstock, may be converted to inorganic halides in a hydrocarbon product stream by one embodiment of the disclosure. The hydrocarbon product is washed with water which binds inorganic halides and is separated from the hydrocarbon stream.

By the wash with water, the inorganic halides from the hydrocarbon stream are removed from the product. These inorganic halides removed from the hydrocarbon stream are taken away from the system, e.g. by regenerating the wash water by evaporation, membrane separation, reverse osmosis or other means of concentrating the impurities in a brine.

In an embodiment, a make-up hydrogen stream is added to the hydrogen rich gas phase prior to the recycling into the hydrotreatment reactor. This is in order to ensure the required hydrogen to be present within the hydrotreatment reactor for the conversion of organic halides into inorganic halides, and possibly also further reactions, such as olefin saturation.

Throughout this text, the term “a material catalytically active in converting organic halides into inorganic halides” is meant to denote catalyst material arranged for and/or suitable for catalyzing the conversion.

“Organic halides” are chemical compounds in which one or more carbon atoms are linked by covalent bonds with one or more halogen atoms (fluorine, chlorine, bromine, iodine or astatine—group 17 in current IUPAC terminology).

“Inorganic halides” are chemical compounds between a halogen atom and an element or radical that is less electronegative (or more electropositive) than the halogen, to make a fluoride, chloride, bromide, iodide, or astatide compound, with the further limitation that carbon is not part of the compound. A typical example of a material catalytically active would be a classical refinery hydrotreatment catalyst, such as one or more sulfided base metals on a refractive support.

The term “removing halides” is meant to include situations where either some of the halides present or all of the halides present are converted into inorganic halides, and subsequently removed. The term is thus not limited to situation where a certain percentage of the halides present are removed.

The term “letting the stream react at the presence of the catalytically active material” is meant to cover bringing the stream into contact with the catalytically active material under conditions relevant for catalysis to take place. Such conditions typically relate to temperature, pressure and stream composition.

The term “thermal decomposition” shall for convenience be used broadly for any decomposition process, in which a material is partially decomposed at elevated temperature (typically 250° C. to 800° C. or perhaps 1000° C.), in the presence of substoichiometric amount of oxygen (including no oxygen). The product will typically be a combined liquid and gaseous stream, as well as an amount of solid char. The term shall be construed to included processes known as pyrolysis, partial combustion, or hydrothermal liquefaction.

### BRIEF SUMMARY OF THE INVENTION

A broad aspect of the present disclosure relates to a process for conversion of a hydrocarbonaceous feed comprising at least 20 ppmw, 100 ppmw or 500 ppmw and less than 1000 ppmw, 5000 ppmw or 10000 ppmw halides, to a hydrocarbon product stream by hydrotreatment, in the presence of a material catalytically active in hydrotreatment and an amount of hydrogen,

wherein said hydrocarbon product stream comprises an amount of ionic halides,
wherein said hydrocarbon product stream is combined with an amount of wash water,
wherein the weight ratio between wash water and hydrocarbon product stream water is above 1:10, 1:5 or 1:2 and below 1:1, 2:1 or 10:1,
and wherein the combined hydrocarbon product stream and wash water are separated in a non-polar stream of hydrocarbon product and a polar stream of wash water comprising ionic halides,
such that from 50%, 90% or 99% to 100% of said ionic halides are transferred from said hydrocarbon product stream to the polar stream of wash water comprising ionic halides,
characterized in said polar stream of wash water comprising ionic halides being directed to a means of concentrating, to provide a stream of purified water and a stream of brine having a concentration of ionic halides being more than 2 times, 5 times or 10 times and less than 50 times or 100 times above that of the polar stream of waste water comprising ionic halides, with the associated benefit of such a process being able to receive a hydrocarbonaceous mixture with a high amount of halides, purifying it to a quality hydrocarbon product while minimizing the consumption of water.

In a further embodiment said means of concentrating is an evaporator, heating the polar stream of wash water comprising ionic halides, to evaporate an amount of water, constituting said purified water, with the associated benefit of an evaporator being an efficient means of concentrating especially in a refinery environment where energy may be available.

In a further embodiment said evaporator is a falling film evaporator configured for flowing the polar stream of wash water comprising ionic halides over a heated surface, and further configured for collecting the evaporated water and directing it as the stream of purified water, with the associated benefit of a falling film evaporator being highly effective in providing an evaporator with a high evaporation surface and a small footprint.

In a further embodiment said means of concentration is a membrane separator or a reverse osmosis separator, with the associated benefit of providing separation with requiring input of thermal energy.

In a further embodiment the pH of said polar stream of wash water comprising ionic halides is adjusted to a value between 6.5 and 9 by addition of an amount of base or acid to either the stream of wash water or the polar stream of wash water comprising ionic halides, with the associated benefit of enabling the means of concentrating to be construction in inexpensive materials.

A further aspect of the disclosure relates to a process for conversion of a raw feed stream rich in molecules comprising C, H and a halide, and optionally O, N, Si, and other elements, such as a mixture rich in plastic, lignin, straw, lignocellulosic biomass or aquatic biological material, said process involving
a. a step of thermal decomposition of said raw feed stream, to provide a precursor to a hydrocarbonaceous feed or a to provide hydrocarbonaceous feed,
b. optionally a step of pre-treatment, for purifying the precursor to hydrocarbonaceous feed to provide a hydrocarbonaceous feed
c. a hydrotreatment step for converting the hydrocarbonaceous feed in the presence of hydrogen, in accordance with any of the previous claims, to provide a hydrocarbon product stream, with the associated benefit of such a process being well suited to convert a raw material such as a mixture rich in plastic, lignin, straw, lignocellulosic biomass or aquatic biological material comprising halides into a purified hydrocarbon.

In a further embodiment said process for conversion of a raw feed is followed by the step of directing the hydrocarbon product stream to a steam-cracking process, with the associated benefit of providing a raw material for petrochemical processes, from e.g. waste products, biological material or low cost resources.

A further aspect of the disclosure relates to a system for hydrotreatment of a hydrocarbonaceous stream comprising
(a) a hydrotreament reactor containing a material catalytically active in hydrotreament, said hydrotreament reactor comprising an inlet for inletting a hydrogen enriched hydrocarbon stream and an outlet for outletting a first product stream,
(b) a means of mixing having two inlets and an outlet,
(c) a means of phase separation, having an inlet and a liquid polar phase outlet, liquid non-polar phase outlet and gas phase outlet,
(d) a means of concentrating, having an inlet, a concentrated brine outlet and a purified water outlet,
   wherein said outlet for outletting a first product stream is in fluid communication with a first inlet of the means of mixing,
      wherein the outlet of the means of mixing is in fluid communication with the inlet of the means of phase separation, and the liquid polar phase outlet of the means of phase separation is in fluid communication with the inlet of the means of concentrating, wherein the purified water outlet of the means of concentrating is in fluid communication with a second inlet of the means of mixing optionally in combination with a further source of purified water
      and wherein the liquid non-polar phase outlet of the means of phase separation is configured for providing a hydrocarbon product, with the associated benefit of such a system being able to convert waste products, biological material or low cost resources to a valuable hydrocarbon product, with a minimal consumption of purified water.

The process and the system disclosed may be found useful where the feed to a hydrotreatment process comprises halides and especially where the temperature must be kept moderate, e.g. to avoid side reactions of olefins and diolefins. Examples of such processes include direct hydrotreatment of waste plastic or hydrotreatment of the product from thermal decomposition of halide rich materials, such as waste plastic, comprising e.g. PVC or other halide containing plastics as well as of biological materials with high halide content, e.g. straw and algae, as well as other products of thermal decomposition or hydrothermal liquification processes, kerogenic feeds such as coal tar or shale oil. The feed may also originate from non-pyrolysed renewable feedstocks, e.g. algae lipids, especially when grown in salt water, or other biological feeds comprising hydrocarbons and chloride.

Ammonia and halides react to form salts, e.g. ammonium chloride, at temperatures below the precipitation temperature typically 150° C. to 300° C. Precipitation of such salts may result in partial or complete or partial blocking of process lines as well as potential corrosion, and must therefore be avoided. Therefore, it is also relevant to be aware of this aspect when defining the process conditions.

After the hydrotreatment of a halide containing hydrocarbonaceous feedstock, an intermediate stream rich in halides, will be present. Depending on the boiling range and temperature, the stream may be a one-phase gas stream or a two-phase stream with a gas stream rich in hydrogen and hydrogenated hetero-atoms, such as hydrochloride and ammonia and a liquid stream comprising mainly hydrocarbons. As the hydrogenated hetero-atoms are water soluble, addition of an amount of wash water and cooling the stream, will result in a three phase stream, comprising a gas phase, an organic non-polar phase and an aqueous polar-phase, which may be separated in a so-called three-phase separator, possibly in combination with a cascade of separators with intermediate cooling and pressure release.

In traditional refinery processes such a water washing process step is also seen, e.g. in the context of nitrogen rich hydrocarbons, which are converted to ammonia, which is highly soluble in water, and which enables withdrawal of hydrogen sulfide as ammonium sulfide in the wash water. The concentration of nitrogen hetero-atoms may be above 1 wt %, and the mass ratio of water consumed to hydrocarbon to is typically 1:20 or 1:10, resulting in a concentration of ammonia salts in water around 1 wt % to 5 wt %. This design is limited by the concentration of ammonium sulfide, however, this concentration is allowed to be up to 2 wt % to 5 wt % before corrosion becomes an issue.

In a process where the hetero-atoms of a hydrocarbonaceous feed are halides, and where they are present in levels above 100 ppmw, it is however necessary to increase the amount of water in the washing process, to achieve quantitative withdrawal of halides from the polar phase, while avoiding corrosion issues from elevated halide concentration in the water phase. With a feedstock comprising 500 ppmw CI and a purified hydrocarbon comprising less than 1 ppmw CI, the mass ratio water to of hydrocarbon may be about 1:1, as typical design limits requires keeping CI levels in the water below 500 ppmw, which correspond to the requirement for carbon steel or regular stainless steel. This amount of water is 10 to 20 times higher than the normal practice in the refinery industry.

Such a high amount is of course an economical and environmental challenge, and therefore it is desirable to reduce the amount of water consumed. This may be done by providing a means of concentration of the used wash water, such that it is separated in purified wash water and a concentrated brine rich in impurities, such as halides. Multiple methods exist for this purpose, including membrane filtration, reverse osmosis or evaporation, including falling film evaporation. The equipment used in the evaporation process will be much more expensive if special grades of steel are required, so it is also beneficial to consider reducing the corrosiveness of the used wash water, e.g. by neutralizing the used wash water. As the wash water in presence of halides typically is acidic, e.g. as low as pH=2 for hydrocarbonaceous feedstocks with a low amount of nitrogen, addition of ammonia or sodium hydroxide may be used to bring pH to a value in the range 6.5-9.0.

The product of the process may be directed to further treatment, either for the production of hydrocarbon transportation fuel of for petrochemical processes, i.e. in a steamcracker.

### BRIEF DESCRIPTION OF THE FIGURE

FIG. 1 discloses a system for treating a hydrocarbon stream.

### DETAILED DESCRIPTION OF THE FIGURE

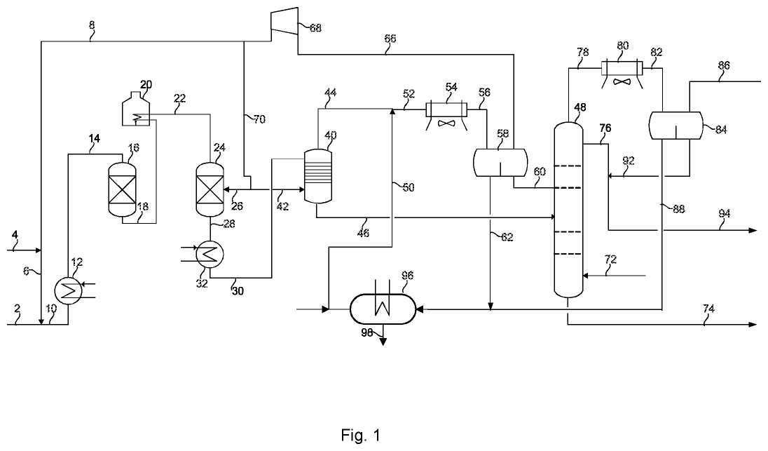

FIG. 1 discloses a system for treating hydrocarbons. Even though some heat exchange units, pumps and compressors are shown in FIG. 1, further pumps, heaters, valves and other process equipment may be part of the system of FIG. 1.

The system of FIG. 1 comprises a sub-system for removing halides from a hydrocarbon stream before the hydrocarbon stream enters a stripper and/or fractionation section.

FIG. 1 shows a hydrocarbon stream 2 containing chlorine. This stream is optionally preheated, before being combined with a hydrogen rich gas stream 6 to a hydrogen enriched hydrocarbon stream 10 in order to ensure the provision of the required hydrogen for the hydrogenation of di-olefins. The hydrogen enriched hydrocarbon stream 10 is heated in heat exchanger 12, and optionally by further heating such as a fired heater to form a heated hydrogen enriched hydrocarbon stream 14. The first reactor 16 is optional, but may have operating conditions at a pressure of about 30 Barg and a temperature of about 180° C., suitable for hydrogenation of di-olefins. The first reactor 16 contains a material catalytically active in olefin saturation and hydro-dehalogenation.

Within the first reactor 16, the heated hydrogen enriched hydrocarbon stream 14 reacts at the presence of the catalytically active material, rendering a first hydrogenated product stream 18.

The first hydrogenated product stream 18 is heated, e.g. in a fired heater 20, and transferred as a heated first hydrogenated product stream 22 to a second reactor 24 where it reacts at the presence of a second catalytically active material. Often quench gas 26 is provided to the second reactor to control the temperature. The first and second catalytically active material may be identical or different from each other and will typically comprise a combination of sulfided base metals such as molybdenum or tungsten promoted by nickel or cobalt supported on a refractory support such as alumina or silica. Typically, the reaction over the first catalytically active material is dominated by saturation of di-olefins, whereas the reaction over the second catalytically active material is dominated by saturation of mono-olefins and hydro-dehalogenation of halide-hydrocarbons, but also hydrodesulfurization, hydrodenitrogenation and hydrodeoxygenation may take place in the second reactor 24 (depending on the composition of the feedstock). Therefore, the hot product stream 28 may comprise hydrocarbons, H₂O, H₂S, NH₃ and HCl, which may be withdrawn by washing and separation. The hot product stream 28 is cooled to form a cooled product stream 30, in heat exchanger 32. The cooled product 30 is directed to a hot stripper 40 where separation is aided by a stripping medium 42, in which the cooled product 30 is split in a gas product fraction 44 and a liquid product fraction 46. The gas product fraction 44 is combined with a stream of purified water 50, providing a mixed stream 52 and cooled in cooler 54, providing a three phase stream 56, which is separated in three-way separator 58, into a light hydrocarbon stream 60, a contaminated water stream 62 and a hydrogen rich gas stream 66. The hydrogen rich gas stream 66 is directed to a recycle compressor 68 and directed as quench gas 26 for the second reactor 24 and as stripping medium 42 for the hot stripper 40, as well as recycle gas 8 to be combined with make-up hydrogen gas 4, forming hydrogen rich gas 6.

The light hydrocarbon stream 60 exiting the three-phase separator 58 enters a second stripper 48 to further separate liquid and gaseous components, with the aid of a stripping medium 72. The light ends output 78 from the second stripper 48 is cooled in cooler 80 and directed as a cooled light ends fraction 82 to a further three-phase separator 84 arranged to separate an off-gas fraction 86 from a water fraction 88 and a hydrocarbon liquid fraction 92. The hydrocarbon liquid fraction 92 from the further three-phase separator 84 is recycled to the second stripper 48, the polar liquid fraction 88 can be combined with the contaminated water stream 62 and be directed to a means of concentrating 96, from which a stream of concentrated brine 98, rich in e.g. NH₄Cl, as well as a stream of purified water 50, comprising a low amount of impurities such as NH₄Cl, are withdrawn. The purified water may, typically together with an added amount of water, be added as pure wash water 50.

1. A process for conversion of a hydrocarbonaceous feed comprising at least 20 ppmw halides, to a hydrocarbon product stream by hydrotreatment, in the presence of a material catalytically active in hydrotreatment and an amount of hydrogen,
wherein said hydrocarbon product stream comprises an amount of ionic halides,
wherein said hydrocarbon product stream is combined with an amount of wash water, wherein the weight ratio between wash water and hydrocarbon product stream water is above 1:10 and below 10:1,
and wherein the combined hydrocarbon product stream and wash water are separated in a non-polar stream of hydrocarbon product and a polar stream of wash water comprising ionic halides,
such that from 50% of said ionic halides are transferred from said hydrocarbon product stream to the polar stream of wash water comprising ionic halides,
wherein polar stream of wash water comprising ionic halides being directed to a means of concentrating, to provide a stream of purified water and a stream of brine having a concentration of ionic halides being more than 2 times and less than 100 times above that of the polar stream of wash water comprising ionic halides.

2. A process according to claim 1, wherein said means of concentrating is an evaporator, heating the polar stream of wash water comprising ionic halides, to evaporate an amount of water, constituting said stream of purified water.

3. A process according to claim 2, wherein said evaporator is a falling film evaporator configured for flowing the polar stream of wash water comprising ionic halides over a heated surface, and further configured for collecting the evaporated water and directing it as the stream of purified water.

4. A process according to claim 1, wherein said means of concentration is a membrane separator or a reverse osmosis separator.

5. A process according to claim 1, wherein the pH of said polar stream of wash water comprising ionic halides is adjusted to a value between 6.5 and 9 by addition of an amount of base or acid to either the stream of wash water or the polar stream of wash water comprising ionic halides.

6. A process for conversion of a raw feed stream rich in molecules comprising C, H and a halide, and optionally O, N, Si, and other elements, said process involving
a. a step of thermal decomposition of said raw feed stream, to provide a precursor to a hydrocarbonaceous feed or a hydrocarbonaceous feed,
b. optionally a step of pre-treatment, purifying the precursor to hydrocarbonaceous feed to provide a hydrocarbonaceous feed
c. a hydrotreatment step for converting the hydrocarbonaceous feed in the presence of hydrogen, in accordance with claim 1, to provide a hydrocarbon product stream.

7. A process according to claim 6, followed by the step of directing the hydrocarbon product stream to a steam-cracking process.

8. A system for hydrotreatment of a hydrocarbonaceous stream comprising
a. a hydrotreament reactor containing a material catalytically active in hydrotreament, said hydrotreament reactor comprising an inlet for inletting a hydrogen enriched hydrocarbon stream and an outlet for outletting a first product stream,
b. a means of mixing having two inlets and an outlet,
c. a means of phase separation, having an inlet and a liquid polar phase outlet, liquid nonpolar phase outlet and gas phase outlet,
d. a means of concentrating, having an inlet, a concentrated brine outlet and a purified water outlet, wherein said outlet for outletting a first product stream is in fluid communication with a first inlet of the means of mixing,
wherein the outlet of the means of mixing is in fluid communication with the inlet of the means of phase separation, and the liquid polar phase outlet of the means of phase separation is in fluid communication with the inlet of the means of concentrating,
wherein the purified water outlet of the means of concentrating is in fluid communication with a second inlet of the means of mixing optionally in combination with a further source of purified water
and wherein the liquid non-polar phase outlet of the means of phase separation is configured for providing a hydrocarbon product.
